(19) United States
(12) Patent Application Publication
(10) Pub. No.: US 2017/0299004 A1
(43) Pub. Date: Oct. 19, 2017

(54) Guide Means For A Brake Lining Arrangement Of A Disc Brake, And Disc Brake

(71) Applicant: Lucas Automotive GmbH, Koblenz (DE)

(72) Inventors: Markus Mallmann, Pfalzfeld (DE); Berthold Ulrich, Mayschoss (DE)

(73) Assignee: Lucas Automotive GmbH, Koblenz (DE)

(21) Appl. No.: 15/511,867

(22) PCT Filed: Sep. 22, 2015
(86) PCT No.: PCT/EP2015/071651

§ 371 Date: Mar. 16, 2017

(30) Foreign Application Priority Data
Sep. 23, 2014 (DE) 10 2014 014 081.4

(51) Int. Cl. F16D 65/097

(52) U.S. Cl. CPC F16D 65/0972

(57) ABSTRACT

A guide means for a brake lining arrangement of a disc brake wherein a lower securing portion has at least one lower retaining portion which engages into a corresponding recess in a brake support and is thereby in secure engagement with the brake support at least in some sections. Furthermore, a stop surface has an upper retaining portion, which has two regions that can be brought into contact with the brake support at least in some sections for positioning purposes, the upper retaining portion being arranged on a guide means such that the retaining portion fixes the guide means axially in both directions when attached to the brake support.

### CROSS-REFERENCE TO RELATED APPLICATIONS

This application is a national stage of International Application No. PCT/EP2015/071651, filed 22 Sep. 2015, the disclosures of which are incorporated herein by reference in entirety, and which claimed priority to German Patent Application No. 10 2014 014 081.4 filed 23 Sep. 2014, the disclosures of which are incorporated herein by reference in entirety.

### BACKGROUND OF THE INVENTION

The present invention relates to a guide means for a brake lining arrangement of a disc brake, having a main part, which comprises: a guiding portion provided for guiding a guiding projection of the brake lining arrangement, which guiding portion has an upper guiding surface, a lower guiding surface and a connecting surface which connects both of these guiding surfaces, an upper fixing portion for fixing the guide means to a brake support, which upper fixing portion has an upper contact surface, a lower contact surface and a stop surface which connects both of these contact surfaces, and a lower fixing portion for fixing the guide means to the brake support, wherein the stop surface of the upper fixing portion can be brought into positioning contact with a corresponding portion of the brake support, wherein the lower fixing portion has at least one lower retaining portion, which engages in a corresponding recess in the brake support and is thereby in retaining engagement with the brake support at least in some sections.

Guide means of this kind are known from the prior art and are disclosed, for example, in the document US 2013/0192938 A1. This document describes a guide means with an upper and lower portion that can be affixed on a brake support as well as a portion provided for guiding a projection of a brake lining support. The upper portion has a first support leg and a second support leg, which rest on surfaces of the brake support provided for this. In addition, the upper portion comprises a retention tab, which can be brought into engagement with the brake support. The portion for guiding a projection of the brake lining arrangement comprises a base leg, an upper leg, a lower leg and two retaining elements arranged to the side of the base leg. The two retaining elements of the guide means rest on opposed lateral surfaces of a brake support portion, in order to be able to hold the guide means in position. In addition, the lower portion also has, apart from a lower abutment leg and an extension leg, a retaining element formed on one side for securing the guide means on the brake support portion provided. The retaining elements are each bent at bending points, which are located on the lateral edges of the guide means, in the direction of the brake support, i.e. the retaining elements are formed elastically on the guide means.

The retaining elements of the guide means are arranged on the guide means in such a way that they are oriented in the direction of the actuating force of the brake lining arrangement. The retaining elements of the guide means are accordingly loaded upon actuation of the brake lining arrangement with the actuating force, as they are intended to hold the guide means in its predetermined position on the portion of the brake support against the actuating force of the brake lining arrangement. This applies in particular to the retaining element formed on one side of the lower portion of the guide means.

So that the retaining elements can withstand the loads due to the actuating force of the brake lining arrangement and also the vibrations occurring during the operation of a vehicle, the elastic retaining elements of the guide means must be designed accordingly and dimensioned appropriately for this load. In particular, the retaining element formed on one side of the lower portion should be designed in such a way that it has an adequately high degree of stiffness in spite of its elastic formation.

The document EP 2 299 142 A1 discloses a guide means for a brake lining arrangement that comprises a receiving portion for mounting on a projection of a brake support. The receiving portion has an upper and a lower holding surface and a connecting surface connecting these two holding surfaces. A holding claw is also provided on the upper holding surface, which claw is pretensioned against an upper side of the projection and engages in a groove on the upper side of the projection in order to counteract falling of the guide means from the brake support.

The document DE 10 2012 010 932 A1 describes a guide means for a brake lining arrangement that comprises a fixing portion with two contact surfaces and a stop surface connecting the two contact surfaces. For the axial fixing of the guide means on a brake support, a retaining portion and at least one elastic retaining bracket are formed on the stop surface. The retaining bracket is provided here on one side of the stop surface and formed elastically to facilitate a compensation of manufacturing tolerances in the fixing on the brake support.

Other guide means according to the prior art are known from the documents WO 2005/064194 A1, DE 10 2012 016 737 A1 and DE 10 2011 160 A1.

In the current prior art, the guide means can often not be fitted in a process-capable manner. The reason for this is the tolerance design of the retaining elements and the maximal overlap resulting with the lateral cast surfaces of the brake support. Restricting the casting tolerance to solve this problem, however, is not technically possible for most foundries.

### BRIEF SUMMARY OF THE INVENTION

A feature of the present invention, therefore, is to provide a guide means that has a higher stiffness and higher strength with reduced material usage and on which a tolerance restriction of the cast surfaces of the brake support can largely be eliminated.

This feature is achieved by a guide means for a brake lining arrangement according to the first main Claim and a disc brake for a motor vehicle braking system according to the second main Claim.

To achieve the feature described above, the stop surface of the guide means according to the invention is provided with an upper rigid retaining portion, which has two sections, which can be brought into contact with the brake support at least in some sections, wherein the upper rigid retaining portion is arranged on the guide means so that it fixes the guide means axially in both directions in a mounted state on the brake support.

By its formation in the stop surface, the retaining portion has a high stiffness, so that the strength and stiffness of the guide means can be increased as a whole without an additional material requirement. Furthermore, by providing the stiff retaining portion—compared with the prior art—the elastic retaining elements of the portion for guiding the projection of the brake lining arrangement can be eliminated. In addition—likewise compared with the prior art—the retaining element formed on one wide of the lower portion can be replaced by another form of implementation.

With the guide means according to the invention, the material requirement needed for the manufacture of the guide means can be considerably reduced, leading to a reduction in the manufacturing costs.

Due to the elimination of laterally arranged elastic retaining brackets, a casting tolerance limitation on the brake support can be eliminated and at the same time process-capable assembly can be facilitated.

The stiffened upper retaining portion can be arranged on the guide means so that each of the two sections of the upper retaining portion can be loaded axially in an opposed direction in a mounted state on the brake support. Put more precisely, one section of the upper retaining portion can be loaded with the actuating force of the brake lining arrangement, while the other section can be loaded with the force on release of the brake lining arrangement from the braking position. The guide means can be fixed axially in both directions by this and held reliably in its predetermined position on the brake support, due to which the service life of the guide means is increased.

According to an embodiment of the present invention, the upper retaining portion can comprise at least one retaining surface, which serves to contact the brake support.

The retaining surface can run at an angle to the stop surface so that it extends substantially parallel to at least the lower contact surface of the upper fixing portion of the guide means. Due to the design of the brake support, the upper retaining portion or the retaining surface can rest respectively flat in the two sections or with the lateral edges of the portion or the surface on the brake support and take up the forces and loads arising. It is naturally possible that the retaining surface can lie flat in the two sections and with one of its lateral edges on the brake support.

In this connection, it can further be provided according to the invention that the retaining surface is angled along one edge, which extends substantially perpendicularly to the lateral edges of the upper fixing portion or to the lateral edges of the main part. The length of the edge on which the retaining surface can be angled and the accompanying size of the retaining surface are used to adjust the stiffness of the upper retaining portion. Since the edge runs parallel to the direction in which the forces and loads occur in a mounted state of the guide means on the brake support, meaning to the direction of the actuating force or the force for releasing the brake lining arrangement, these loads can be taken up over the length of the edge and the size of the retaining surface in the two sections. A retaining portion of this kind provides a very high stiffness without additional material being required.

The upper retaining portion can extend, according to one embodiment of the invention, between the stop surface and at least one of the contact surfaces. The retaining surface can be connected in this case to at least one of the contact surfaces. In other words, the upper retaining portion can be formed by a retaining surface running parallel to at least the lower contact surface and another surface section running substantially parallel to the stop surface. The other surface section then passes over into one of the contact surfaces.

According to another embodiment of the invention, the two sections of the upper retaining portion can be formed respectively starting out from one of the lateral edges of the guide means, more precisely speaking, of the upper fixing portion, in the direction of the middle of the guide means.

Furthermore, the two sections of the upper retaining portion can be formed separately from one another. In this case, the upper retaining portion is not formed as a continuous portion, but has two spatially distanced sections. These two sections can each take up axial loads in opposed directions in a mounted state on the brake support and thus fix the guide means axially on the brake support. By this embodiment the two spatially separate sections of the upper retaining portion can be brought into contact at least in some sections with two lateral surfaces of a same projection of the brake support, wherein each section can be brought into contact respectively with one of the two lateral surfaces.

A further development of the invention provides that the stop surface is formed at least in some sections as an elastic retaining bracket. To this end the stop surface can be angled upwards in a section between two spatially separate sections of the upper retaining portion so that it forms an elastic retaining bracket, which can be placed at least in some sections on a corresponding projection of the brake support. The upper contact surface can be formed separately from the retaining bracket in the area of the retaining bracket in this embodiment.

The upper contact surface can further be formed, at least in some sections, as a clamping component, which is supported in operation with respect to a projection of the brake support and serves to fix the guide means on the brake support tangentially and radially. The clamping component can be formed in this case in a portion between the two sections of the upper retaining portion.

The upper contact surface or the clamping component can have at least two snap claws or have the shape of a double tongue, which comprises two tongue portions, in order to hold the guide means on the brake support.

According to the invention, the at least two snap claws or the two tongue portions can at least partially encompass a corresponding centering projection on the brake support in operation. An unintentional radial and/or tangential release of the guide means from the brake support can be counteracted by this. In other words, the guide means can be held on the brake support by encompassing of the centering projection by the snap claws or tongue portions. In addition, the interaction, i.e. the encompassing, of the snap claws or tongue portions with the centering projection can create a centering effect during the assembly of the guide means on the brake support. An envisaged fixing of the guide means on the brake support, for example during a change of brake linings, can be simplified by this.

Furthermore, the stop surface can have at least one centering recess, which is formed corresponding to the centering projection of the brake support. The centering recess can be provided in this case on the elastic retaining bracket. It can be ensured by the centering recess that no disruptive contact and/or overlap of the inside of the stop surface facing the brake support occurs with the centering projection during operation or when assembly is complete. The envisaged fixing of the guide means on the brake support in the correct position is also ensured by this.

The double tongue can be supported on the projection of the brake support via the two tongue portions respectively in a punctiform manner. In this case the two tongue portions each have a rounded formation towards the brake support. Since the two point contacts together act like a linear contact, an improved clamping of the guide means to the brake support can thus be achieved compared with simply formed tongue components. Alternatively, the two tongue portions can have a linear impact on the brake support, at least in some sections, instead of a point impact on the brake support. According to this embodiment, the two tongue portions are formed flat for supporting with respect to the brake support. The double tongue can further have two identically formed tongue portions with point or linear impact on the brake support or a combination of two tongue portions formed in a different way. What is described above can also apply to the at least two snap claws.

Alternatively, however, instead of the double tongue, a simply formed tongue component or a simply formed clamping portion with a point or linear contact region for point or linear contact can be provided. The double tongue or the clamping section can also be formed so that it is connected to the upper contact surface outside of the portion between the two sections of the upper retaining portion only via a head portion.

According to a further development of the invention, lateral insertion tabs can be formed on the guiding portion. The insertion tabs on the guiding portion of the guide means make it easier to insert a guiding projection of the brake lining arrangement into the guiding portion of the guide means. The lateral insertion tabs can be formed at an angle for this purpose, so that the guiding projection of the brake lining arrangement requires less accurate positioning on insertion. The insertion tabs guide or “center” the guiding projection in the guiding portion.

According to another embodiment, at least one contact claw can be provided on the guiding portion, which claw projects beyond the main part in the direction of the brake support. The at least one contact claw can be arranged on an upper or lower end of the connecting surface of the guiding portion in this case. In addition, the at least one contact claw can be provided laterally or centrally on the connecting surface of the guide portion. The at least one contact claw can be supported with respect to a portion of the brake support for taking up the guiding portion of the guide means, in order to permit an elastically pretensioned, fixed seat of the guide means on the brake support and thus to fix the guide means tangentially on the brake support. The at least one contact claw can be supported in a punctiform manner or two-dimensionally at least in some sections with respect to the brake support. The at least one contact claw can be formed rounded or flat in the direction of the brake support for this purpose.

Another embodiment can have two contact claws arranged laterally and/or a centrally arranged contact claw, which are arranged at opposing upper and lower ends of the connecting surface of the guiding portion. The two laterally arranged contact claws can be provided in this case at the lower end and the centrally arranged contact claw at the upper end. The guide means can be effectively fixed or clamped on the brake support tangentially via opposed forces by this arrangement. If several contact claws are provided on the guide means, these can have either the same punctiform or flat formation or a combination of different configurations.

According to a further development of the invention, the guiding portion can have a reset spring acting on the brake lining arrangement. The reset spring can be formed to move the brake lining back into its starting position following braking, in order to prevent permanent grinding of the brake linings on a brake disc. For this purpose the reset spring has an extension, which reaches through under a lining support in the direction of the brake disc, so that an angled stop on the extension engages behind the lining support. In addition, the reset spring comprises a loop, which is formed so that it permits an elastic behavior to move the brake lining arrangement back out of the braking position on the one hand and on the other hand can provide a necessary plastic deformation if a brake lining wear limit or a defined actuation free travel is exceeded.

In another embodiment of the invention, a lip section is provided on the lower fixing portion. The lip section can adjoin the contact surface of the lower fixing portion and be at an angle from this. In addition, the lip section can have a curved cross section. In a mounted state on the brake support, the lip section can be in contact, at least in some sections, with the brake lining support, due to which a force acts on the lip section, which pretensions the lip section against the brake lining support. An additional pressing force can be exerted on clamping components and/or contact claws of the guide means by this via a lever-triggered force transmission. This can further increase the tangential fixing and thus the restraining effect of the guide means on the brake support. In a state when not in contact with the brake lining support, the tangential fixing can be counteracted, on the other hand, by a raising of the lip section or by a force on its underside. Disassembly and a release of the guide means from the brake support can be aided by this.

The lower retaining portion of the lower fixing portion can be formed as a projecting tongue according to another embodiment of the invention. The projecting tongue can be in retaining engagement, at least in some sections, with a corresponding recess of the brake support. Due to this, the lower retaining portion or the projecting tongue can be loaded by the actuating force of the brake lining arrangement in a mounted state on the brake support, due to which the guide means can be fixed axially on the brake support and held in its envisaged position.

According to a further development, the main part of the guide means can have a substantially S-shaped form.

The guide means can further be manufactured from sheet metal. The guide means can be formed in one piece in this case.

The present invention further relates to a disc brake for a motor vehicle braking system with a brake lining arrangement, which has a brake lining support and a brake lining fitted to the brake lining support, which brake lining can be brought into interaction with a brake disc to achieve a braking effect, a brake support, which has at least one receiving area and an upper and a lower fixing area, and a guide means of the type described above, which is fixed on the fixing areas of the brake support by its fixing portions and its guiding portion is taken up in the receiving area of the brake support, wherein the brake lining support has at least one guiding projection, which is guided movably in the guiding portion of the guide means.

In another embodiment, the upper fixing area of the brake support can be configured in the form of a projection. The upper retaining portion of the upper fixing portion of the guide means can be supported in this case axially in both directions on the upper fixing area of the brake support. The guide means can thereby take up axial loads in both directions.

The upper fixing area of the brake support can further have recesses on its opposed lateral surfaces to support the fixing of the guide means on the brake support, in which recesses a section of the upper retaining portion of the upper fixing portion of the guide means can engage respectively.

The centering projection, which is provided to be encompassed at least partially by the at least two snap claws or tongue portions of the upper contact surface of the guide means, can be formed on the upper fixing area of the brake support. According to the invention, the centering projection can be configured in the form of a single projection, which extends substantially in a direction opposite to the lower fixing area. The centering projection can have a transition radius in a transition area in which the centering projection merges into the brake support, wherein the snap claws or tongue portions can substantially encompass this transition radius retentively or can grip on this retentively. The centering projection thus serves to fix the guide means securely on the brake support.

In addition, the centering projection can be formed on the upper fixing area of the brake support so that it merges in some sections via its transition radius into a lateral surface of the upper fixing area, which surface faces the stop surface of the guide means in operation. The guide means, more accurately speaking the snap claws or tongue portions, can thereby come into contact with the centering projection at the earliest opportunity on assembly, due to which this acts in the meantime in a positioning manner on the guide means. The centering projection can thus have a centering function in addition to a securing function.

The centering projection can be cast on the brake support.

Other advantages of this invention will become apparent to those skilled in the art from the following detailed description of the preferred embodiments, when read in light of the accompanying drawings.

### BRIEF DESCRIPTION OF THE DRAWINGS

FIGS. 1, 2 are views in perspective of a guide means according to a first embodiment of the invention;

FIG. 3 is a view in perspective of a brake support according to the invention;

FIG. 4 is a view in perspective of the brake support according to FIG. 3 with guide means fitted thereon according to the first embodiment of the invention;

FIG. 5 is a view in perspective of a disc brake according to the invention with guide means according to the first embodiment of the invention;

FIG. 6 is a view in perspective of a guide means according to a second embodiment of the invention;

FIG. 7 a view in perspective of a guide means according to a third embodiment of the invention;

FIG. 8 is a view in perspective of a disc brake according to the invention with a guide means according to the third embodiment of the invention;

FIGS. 9, 10 are views in perspective of a guide means according to a fourth embodiment of the invention;

FIG. 11 is a view in perspective of the brake support according to FIG. 3 with guide means fitted thereon according to the fourth embodiment of the invention

FIGS. 12, 13 are views in perspective of a guide means according to a fifth embodiment of the invention; and

FIG. 14 is a view in perspective of another brake support according to the invention with a guide means according to the fifth embodiment to be fitted thereto.

### DETAILED DESCRIPTION OF THE INVENTION

A guide means 10 shown in FIG. 1 has a main part 12, which comprises a guiding portion 14, an upper fixing portion 16 and a lower fixing portion 18. Together the guiding portion 14, the upper fixing portion 16 and the lower fixing portion 18 define the substantially S-shaped design of the main part 12 of the guide means 10. The guide means 10 is formed in one piece.

The guiding portion 14 is provided for guiding a guiding projection of a brake lining arrangement (not shown). The guiding portion 14 has an upper guiding surface 14a (not recognizable in FIG. 1) and a lower guiding surface 14c lying opposite the upper guiding surface 14a, which are connected to one another by a connecting surface 14b. The connecting surface 14b extends here virtually perpendicularly to the two opposing guiding surfaces 14a and 14c.

The upper fixing portion 16 comprises an upper contact surface 16a and a lower contact surface 16c, which are connected to one another via a stop surface 16b. The stop surface 16b extends virtually perpendicularly to the lower contact surface 16c. The upper contact surface 16a is angled slightly upwards.

The stop surface 16b is provided with a stiffened upper retaining portion 20. The upper retaining portion 20 is configured in the embodiments shown in the form of two sections separated spatially from one another. The detailed descriptions of the two sections are explained below generally for the upper retaining portion. These are intended to apply equally to both sections formed. Listing the reference sign twice for the two sections has been dispensed with on account of clarity, therefore.

The upper retaining portion 20 comprises a retaining surface 22, which extends substantially parallel to the lower contact surface 16c of the upper fixing portion 16. The retaining surface 22 is angled on one edge 24a and runs accordingly at an angle to the stop surface 16b. The edge 24 extends substantially perpendicularly to the lateral edges 12a and 12b of the main part 12 of the guide means 10.

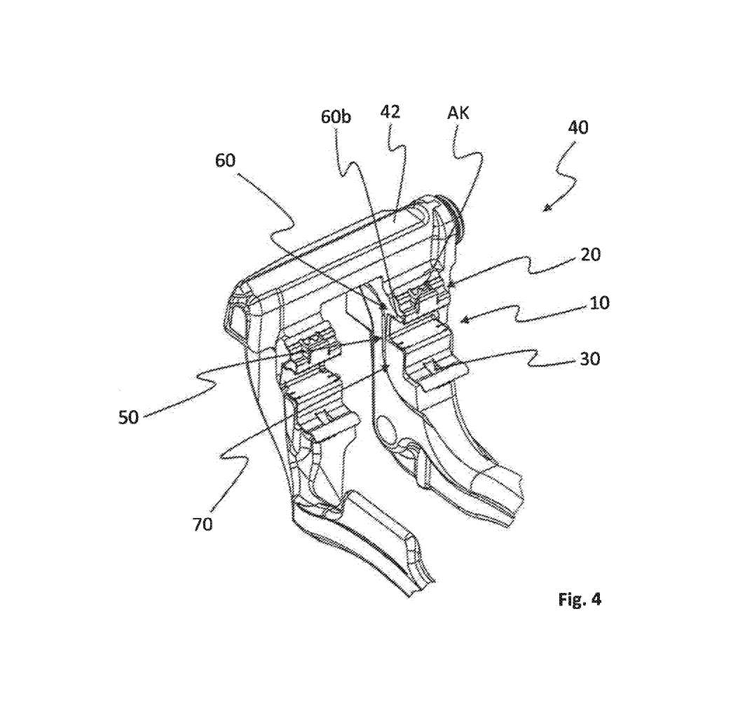

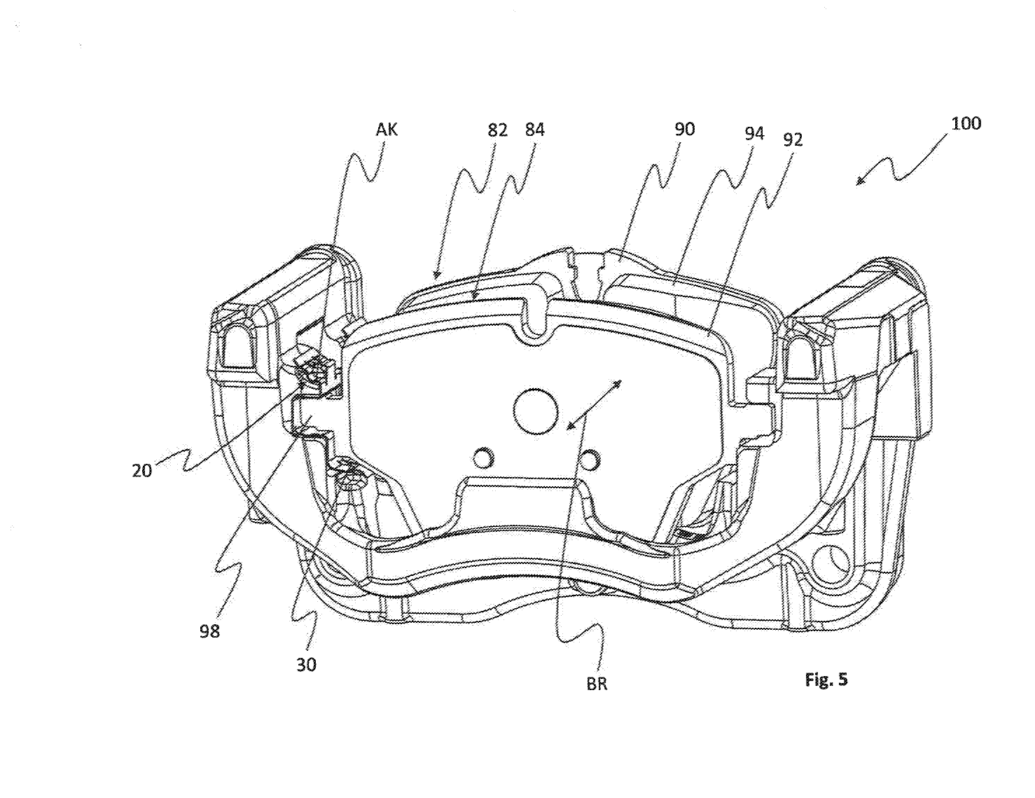

A lateral edge AK of the retaining surface 22 extends perpendicularly to the edge 24 and can rest on the brake support in a mounted state of the guide means 10 on the brake support (see FIGS. 4 and 5). The length of the edge 24 and the lateral edge AK determine the size of the retaining surface 22 and thus define the area with which the upper retaining portion 20 can take up the forces and loads exerted on the guide means 10.

The upper retaining portion 20 extends between the stop surface 16b and the contact surface 16a, i.e. next to the retaining surface 22 and the upper retaining portion 20 comprises another portion 26, which connects the retaining surface 22 to the contact surface 16a. The upper retaining portion 20 thus extends in a stepped manner starting from the stop surface 16b to the contact surface 16a and is designed in the form of a loop inwards in the direction of the brake support starting from the stop surface 16b.

The upper retaining portion 20 is formed so that it fixes the guide means 10 axially in both directions in a mounted state on the brake support. The upper retaining portion 20 is formed for this purpose in two sections separated from one another, which each extend, starting out from opposing lateral edges of the upper fixing portion 16, in the direction of the center of the guide means. A portion of the stop surface 16b and the upper contact surface 16a is provided between the two sections of the upper retaining portion 20. Due to this spatially separated design of the upper retaining portion 20, both sections can be brought into contact with the brake support at least in some sections and can be loaded axially in opposed directions in a mounted state on the brake support.

The portion of the stop surface 16b of the upper fixing portion 16 lying between the two sections of the upper retaining portion 20 is formed as an elastic retaining bracket 34. To do this, said portion of the stop surface 16b is bent at an angle at the upper end along an edge and can thus clasp a projection of the brake support provided for this. The retaining bracket 34 is formed separately from the contact surface 16a of the upper fixing portion 16.

In the portion between the two sections of the upper retaining portion 20, opposite the retaining bracket 34, the contact surface 16a is formed as a clamping section in the form of a double tongue 35a, which has two adjacent tongue portions. The double tongue 35a is supported with respect to the brake support in a mounted state on the brake support. Due to the geometrical configuration, the double tongue 35a has a point contact in each of the two tongue portions. At the same time, the two point contacts lie on one line and thus act additionally as a linear contact, due to which an improved clamping with the brake support is achieved compared with simply formed tongue portions. The double tongue 35a is provided in such a manner on the guide means that it is connected to portions of the upper contact surface 16a lying outside of the portion of the double tongue 35a only via a head portion 36.

The guiding portion 14 further comprises insertion tabs 37a and 37b, which aid the insertion of a guiding projection of a brake lining arrangement (not shown). The guiding tabs 37a and 37b run at an angle to the lower guiding surface 14c.

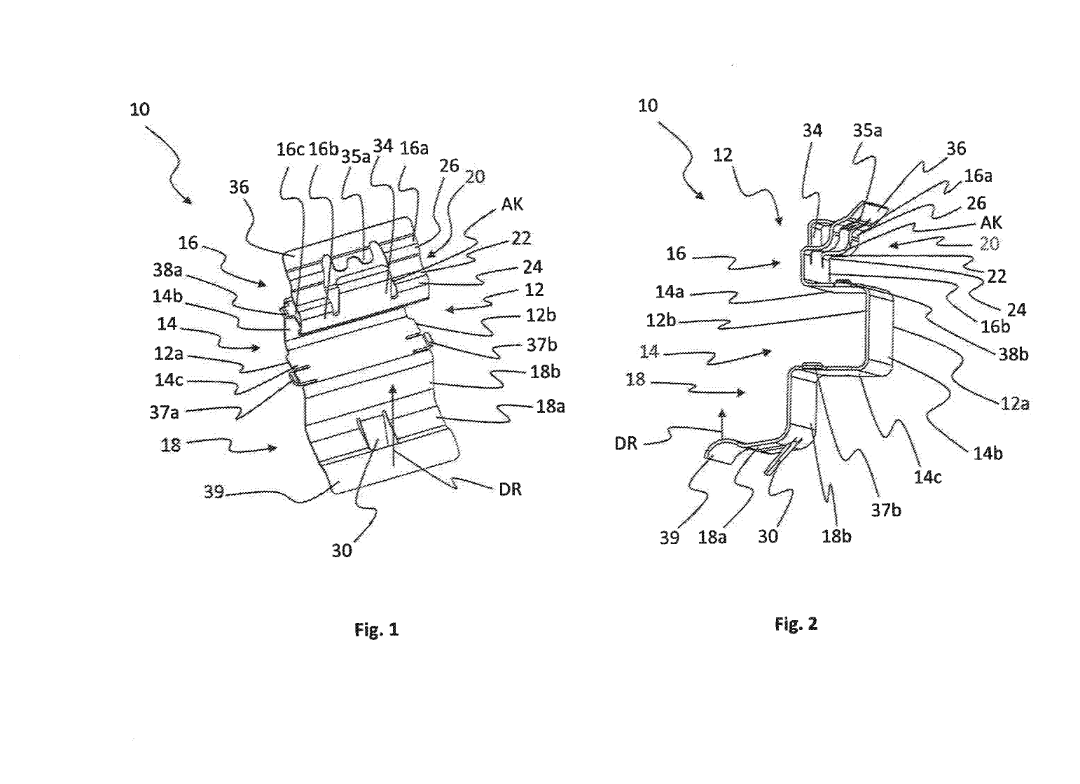

Other tabs 38a and 38b (see FIG. 2) are provided, which run at an angle to the upper guiding surface 14a (see FIG. 2) and act as insertion tabs for a guiding projection of a brake lining arrangement (not shown) and additionally as a stop tab for a projection of a brake support (not shown), which is taken up in the upper fixing portion 16.

The lower fixing portion 18 of the guide means 10 has a contact surface 18a, a stop surface 18b and a retaining portion 30. The retaining portion 30 is formed as a projecting tongue and can be brought into contact with the brake support at least in some sections. A lip section 39 is also provided on the contact surface 18a of the lower fixing portion 18. The lip section 39 has a curved cross section and is elastically pretensioned by its arrangement. In a mounted state on the brake support, a brake lining arrangement acts from above on the lip section 39 at least in some sections, which has a positive effect on the fixing of the guide means 10 on the brake support. In addition, to dismantle the guide means 10 from the brake support, the lip section 39 can be raised or a force exerted on its underside in the direction of the arrow DR, whereby the guide means 10 is released from the brake support.

FIG. 2 shows another view in perspective of the guide means 10 according to the first embodiment of the invention.

The S-shaped design of the main part 12 of the guide means 10 is again recognized in FIG. 2 with the guiding portion 14, the upper fixing portion 16 and the lower fixing portion 18. In addition, the upper guiding surface 14a of the guiding portion 14 and the tab 38b are recognizable in this view.

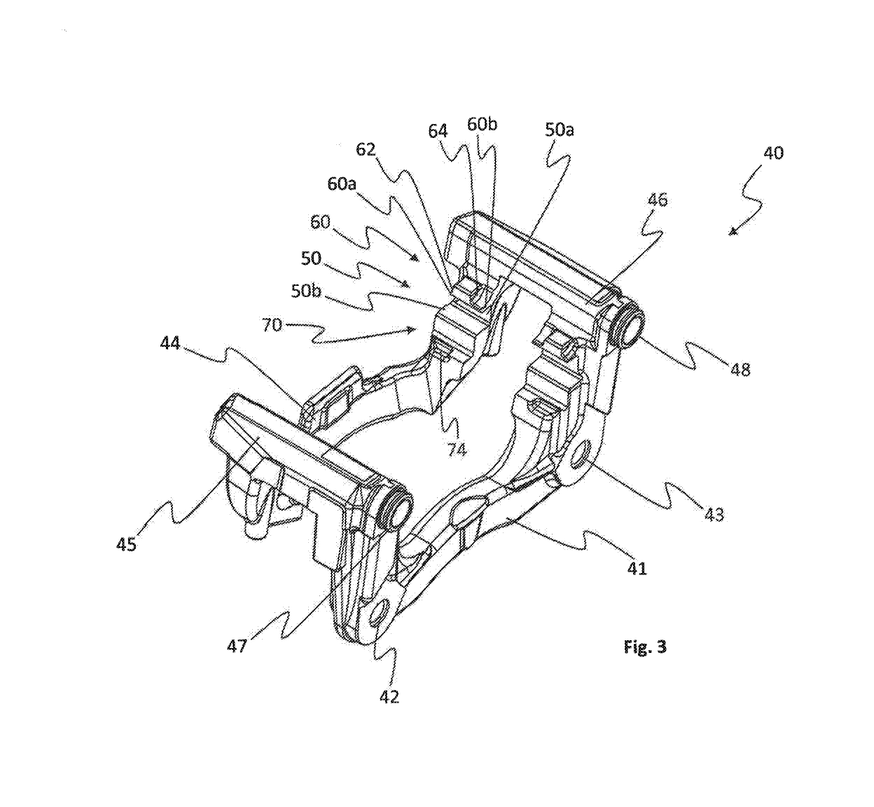

The brake support 40 shown in FIG. 3 has a screw-on bracket 41, in which fixing openings 42 and 43 are formed. The fixing openings 42 and 43 are used to fix the brake support 40 on a wheel carrier, which is not shown. Apart from the screw-on bracket 41, the brake support 40 comprises a longitudinal bracket 44 running parallel to the screw-on bracket 41. The screw-on bracket 41 and the longitudinal bracket 44 are connected to one another by crossbars 45 and 46. Receiving openings 47 and 48 are formed in the crossbars 45 and 46, in which openings guide bolts (not shown) of a floating brake caliper (also not shown) can be taken up.

The brake support 40 further comprises a receiving area 50, an upper fixing area 60 and a lower fixing area 70 for the guide means 10 shown in FIGS. 1 and 2. The receiving area 50 of the brake support 40 can take up the guiding portion 14 of the guide means 10 (not shown) here. The receiving area 50 is defined by the surfaces 50a and 50b as well as the underside (not shown) of the upper fixing area 60.

The upper fixing portion 16 of the guide means 10 (FIGS. 1 and 2) can be attached to the upper fixing area 60. The upper fixing area 60 is formed as a projection and has a recess 62 and 64 respectively on its opposed lateral surfaces 60a and 60b.

The lower fixing portion 18 of the guide means 10 (FIGS. 1 and 2) can be attached to the lower fixing area 70. The lower fixing area 70 is in the form of a step and has a lower recess 74.

FIG. 4 shows a section of a view in perspective of the brake support 40 according to FIG. 3 with guide means 10 fitted thereto.

The upper fixing portion 16 of the guide means 10 is plugged onto the upper fixing area 60 of the brake support 40 formed as a projection. Expressed in another form, the upper fixing portion 16 of the guide means 10 takes up the upper fixing area 60 of the brake support 40 between the surfaces 16a, 16b and 16c as well as between the retaining bracket 34 and the double tongue 35a.

The upper retaining portion 20 of the upper fixing portion 16 of the guide means 10 engages with the two sections in the recesses 62 and 64 in the opposed lateral surfaces 60a and 60b of the upper fixing area 60.

The guiding portion 14 of the guide means 10 is received in the receiving area 50 of the brake support 40, so that a guiding projection of a brake lining arrangement (not shown) can be guided in the guiding portion 14 of the guide means 10.

The lower fixing portion 18 of the guide means 10 is placed on the lower fixing area 70 of the brake support 40 formed as a step. Here the lip section 39 protrudes beyond the lower fixing area 70 of the brake support 40. The lower retaining portion 30 in the form of a projecting tongue engages in a lower recess 74 of the lower fixing area 70.

The upper retaining portion 20 engages in the recesses 62 and 64 in the upper fixing area 60 of the brake support 40. The upper retaining portion 20 is thus adapted with its retaining surface 22, which runs at an angle to the stop surface 16b on the edge 24 (FIGS. 1 and 2), to the shape of the recesses 62 and 64. Since the upper fixing area 60 with the recesses 62 and 64 is formed stepped, the upper retaining portion 20 with its step shape can rest on the recesses 62 and 64. In particular, the retaining surface 22 and its lateral edge AK facing the upper fixing area 60 contact the recesses 62 and 64 and the lateral surfaces 60a and 60b.

The disc brake 100 shown in FIG. 5 for a motor vehicle braking system comprises brake lining arrangements 82 and 84, which each have a brake lining support 90 and 92 and each have a brake lining 94 and 96 (not shown) fitted on the brake lining supports 90 and 92. A guiding projection 98 is provided respectively on both sides on the brake lining support 90 and 92, which projection is guided movably in the guiding portion 14 of the guide means 10. As already mentioned, the guiding portion 14 of the guide means 10 is received in the receiving area 50 of the brake support 40.

The arrow BR in FIG. 5 shows the actuating direction of the brake lining arrangements 82 and 84, in which direction the brake lining arrangements 82 and 84 are moved upon braking and upon release of the brakes. Upon braking, the brake lining arrangements 82 and 84 are displaced towards one another in the direction of the arrow BR, in order to be able to enter into interaction with a brake disc, which is not shown.

It results from this that on a brake actuation, the guide means 10 or the upper retaining portion 20 and the lower retaining portion 30 of the guide means 10 are loaded via the guiding projection 98 of the brake lining arrangements 82 and 84 with the actuating force from the direction of the arrow BR. Correspondingly on release of the brake in the opposite direction of the arrow BR, the upper retaining portion 20 of the guide means 10 is loaded via the guiding projection 98 of the brake lining arrangements 82 and 84. Even if the brake is not actuated, vibrations occur in the operation of a vehicle that act in both directions of the arrow BR on the guide means 10 or the retaining portions 20 and 30.

As is recognized from FIG. 5, the stiffened upper retaining portion 20 is formed on the guide means 10 in such a way and the guide means 10 positioned in such a way on the brake support 40 that the stiffened upper retaining portion 20 can take up the actuating force of the brake lining arrangements 82 and 84 occurring in the event of brake actuation and the force occurring on release of the actuating force in both directions of the arrow BR via the two sections. The length of the edge 24 (FIGS. 1 and 2) and the lateral edge AK of the retaining surface 22 determine the area with which the upper retaining portion 20 can take up the loads exerted on the guide means 10.

Since the upper retaining portion 20 can reliably take up the actuating force, the guide means 10 has a high strength, which leads to a long service life of the guide means 10.

In addition, this effect is amplified by the lower retaining portion 30, which can likewise take up the actuating force of the brake lining arrangements 82 and 84 occurring in the direction of the arrow BR in the event of brake actuation.

In the other embodiments of the invention described below, the same reference signs are used for similar components or components with a similar action as in the first embodiment described above, but a consecutive number prefix is added, starting with 2. The components that are not described afresh in the other embodiments match the corresponding components of the first embodiment in their formation and function. The reference signs of these components are dispensed with for the sake of clarity in the associated figures of the other embodiments.

Since the construction of the guide means 210 shown in FIG. 6 according to the second embodiment is similar to the construction of the guide means according to the first embodiment above, only the differences between the two embodiments are looked at in more detail here.

The guide means 210 again has an S-shaped main part 212. The main part 212 comprises a guiding portion 214, an upper fixing portion 216 and a lower fixing portion 218.

In addition to the features of the guide means according to the embodiment described above, the guide means 210 has contact claws 217a and 217b on the connecting surface 214b, which claws are arranged laterally on the connecting surface 214b and lie opposite one another. The contact claws 217a and 217b are formed so that they project downwards beyond the main part in the direction of the brake support (not shown). In a mounted state on the brake support, these contact claws are supported with respect to a surface of a receiving area of the brake support and fix the guide means tangentially on the brake support.

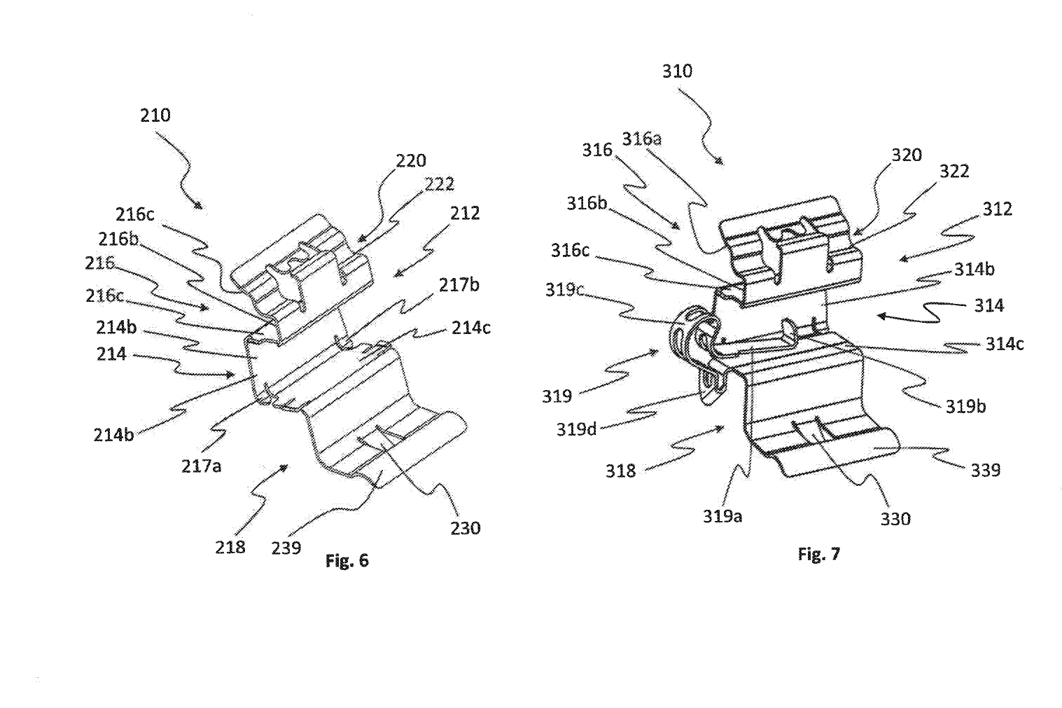

FIG. 7 shows a guide means 310 according to a third embodiment of the invention.

Since the construction of the guide means 310 according to the third embodiment is similar to the construction of the guide means according to the second embodiment described above, only the differences between the two embodiments are looked at in more detail here.

The guide means 310 again has an S-shaped main part 312. The main part 312 comprises a guiding portion 314, an upper fixing portion 316 and a lower fixing portion 318.

The guide means 310 has on the lower guiding surface 314c of the guiding portion 314 a reset spring 319 acting on the brake lining arrangement, which spring serves to move the brake lining arrangement back to its starting position after completed braking, in order to prevent permanent grinding of the brake linings on the associated disc brake. The reset spring 319 comprises an extension 319a, which reaches through under a brake lining support in the direction of a brake disc, so that a stop 319b formed at an angle engages behind the brake lining support. In addition, the reset spring 319 comprises a structurally developed loop 319c, which permits a threshold to be set between a purely elastic behavior and a necessary plastic deformation when a brake lining wear limit is exceeded.

The reset spring 319 can be formed in one piece with the guide means. In this case the deflection 319d of the reset spring 319 preferably at an angle of 45° permits the sheet metal to be cut to size in a way that saves material.

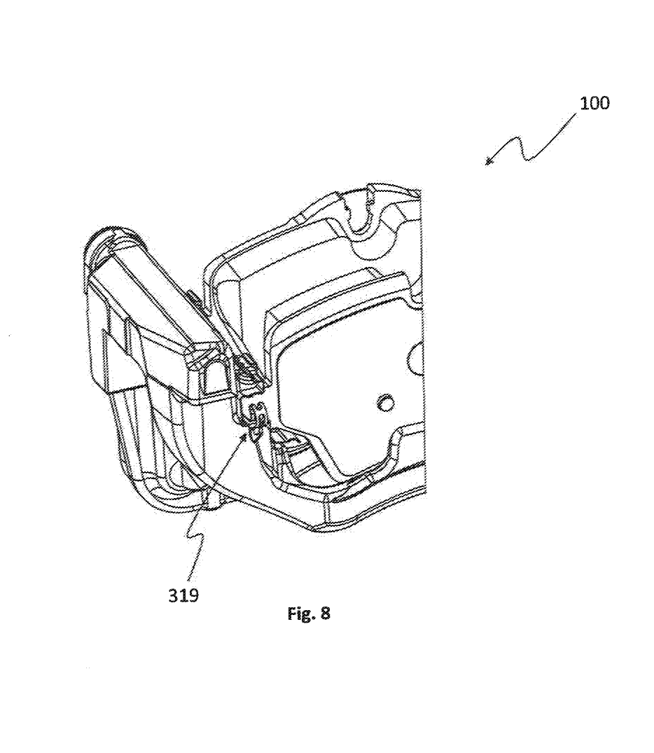

FIG. 8 shows a view in perspective of the disc brake 100 for a motor vehicle braking system with a brake support, a brake lining arrangement and a guide means 310 according to the third embodiment.

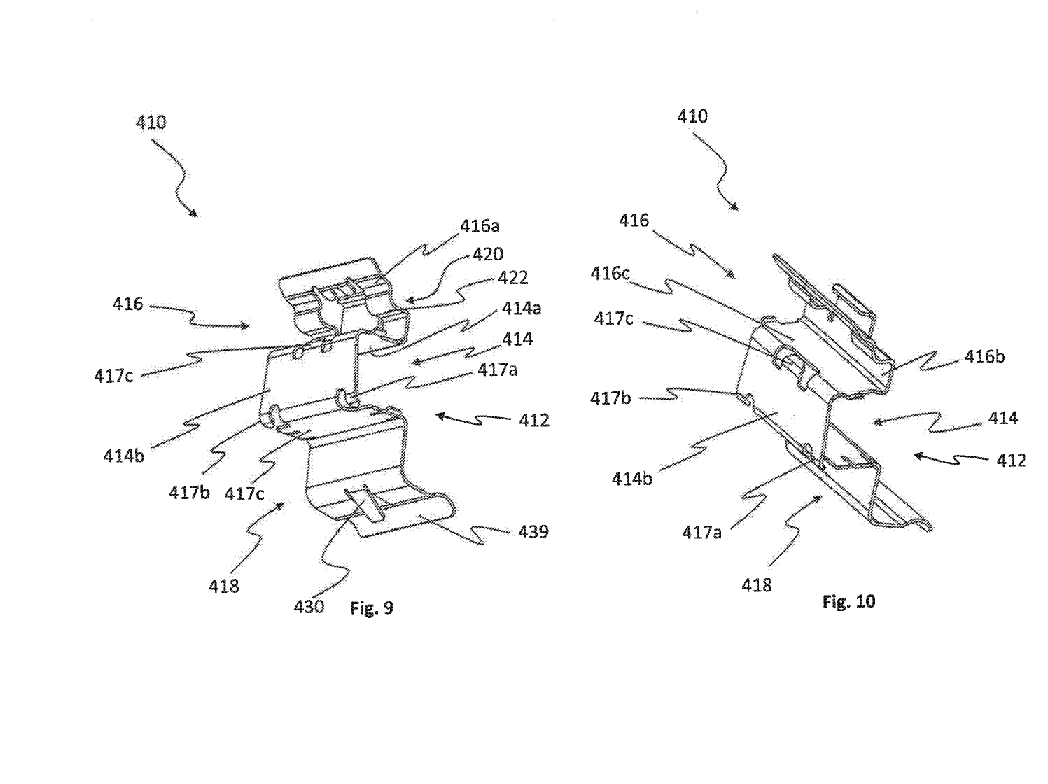

FIGS. 9 and 10 show a guide means 410 according to a fourth embodiment of the invention.

Since the construction of the guide means 410 according to the fourth embodiment is similar to the construction of the guide means according to the embodiments described above, only the differences between the two embodiments are looked at in more detail here.

The guide means 410 again has an S-shaped main part 412. The main part 412 comprises a guiding portion 414, an upper fixing portion 416 and a lower fixing portion 418.

In addition to two laterally arranged contact claws 417a and 417b, which lie opposite one another, the guide means 410 also has a centrally arranged contact claw 417c in the connecting surface 414b of the guiding portion 414. The two laterally arranged contact claws 417a and 417b are provided in this case in the lower area of the connecting surface 414b and are formed so that they protrude downwards beyond the main part 412 in the direction of the brake support (not shown). The centrally arranged contact claw 417c, on the other hand, is provided in the upper area of the connecting surface 414b and formed so that it protrudes beyond the main part 412 upwards in the direction of the brake support (not shown). In a mounted state on the brake support, the laterally arranged contact claws 417a and 417b and the centrally arranged contact claw 417c are each supported with respect to a surface of a receiving area of the brake support and fix the guide means tangentially on the brake support. The guide means is effectively clamped on the brake support by the opposing clamping.

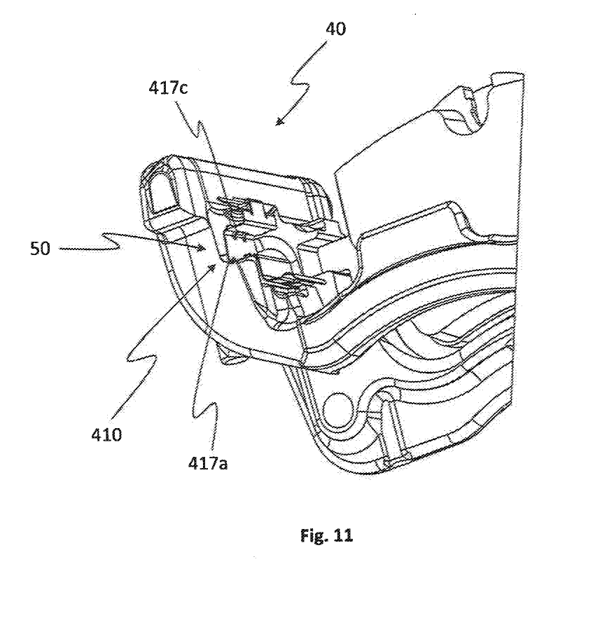

FIG. 11 shows a section of a view in perspective of the brake support 40 according to FIG. 3 with guide means 410 according to the fourth embodiment fitted thereon.

The centrally arranged contact claw 417c and the laterally arranged contact claws 417a and 417b (not shown) are supported with respect to opposing surfaces of the receiving area 50 of the brake support. The guide means 410 is thus clamped on the brake support via forces acting against one another and fixed on this tangentially.

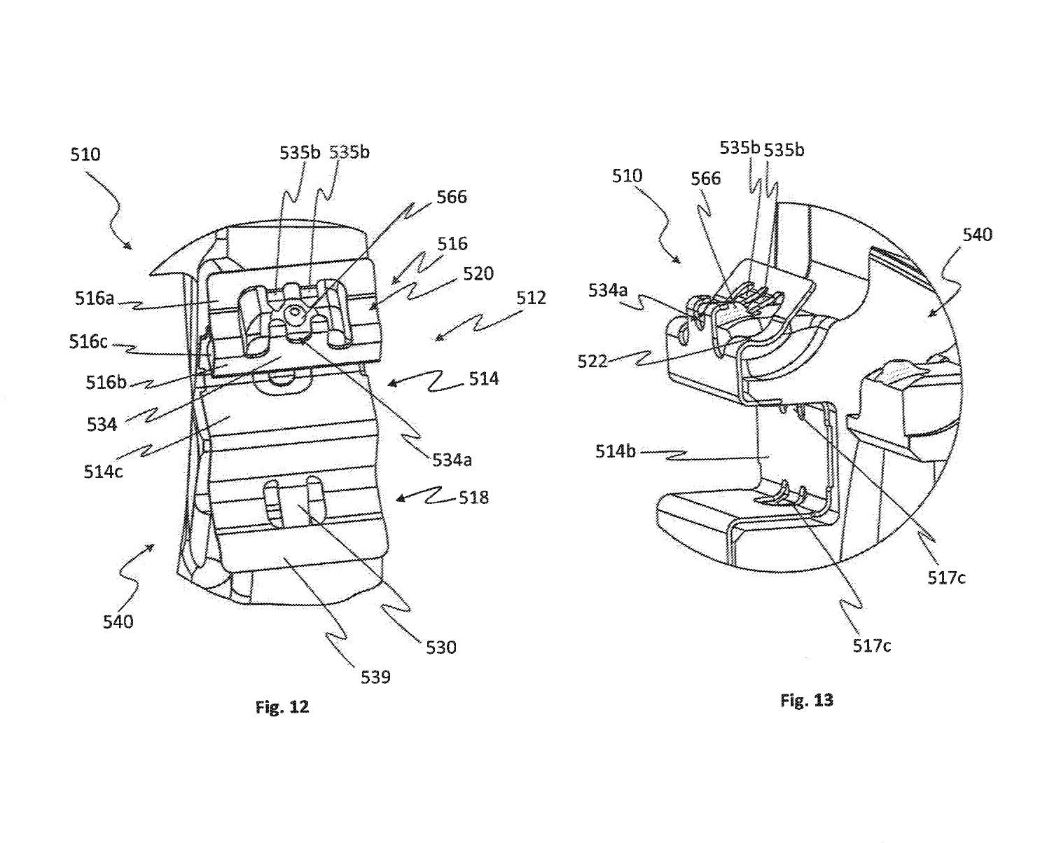

FIGS. 12 and 13 show a guide means 510 according to a fifth practical example of the invention in a mounted state on another brake support 540. Since the construction of the guide means 510 according to the fifth embodiment is similar to the construction of the guide means according to the embodiments described above, only differences between the embodiments are looked at in more detail here. The same applies to the other brake support 540 shown partially in FIGS. 12 and 13 with regard to the brake support 40 described previously.

In contrast to the previous embodiments, the guide means 510 has two snap claws 535b on the upper contact surface 516a of the upper fixing portion 516, which claws extend substantially parallel to one another in the direction of the stop surface 516b and are spaced at a distance from one another. The snap claws 535b are arranged in this case in a central area of the upper contact surface 516a.

Furthermore, a centering recess 534a is formed in the stop surface 516b of the upper fixing portion 516. More precisely speaking, the centering recess 534a is provided in the area of the elastic retaining bracket 534 and extends, starting out from an upper end of the elastic retaining bracket, in the direction of the lower contact surface 516c. The centering recess is arranged centrally between two recess-free sections of the elastic retaining bracket 534.

Moreover, the guide means 510 has two centrally arranged contact claws 517c on the connecting surface 514b of the guiding portion 514, which claws are formed on opposing upper and lower ends of the connecting surface 514b and respectively project beyond the main part of the guide means 510.

The brake support shown in FIGS. 12 to 14 differs from the brake support described with reference to FIG. 3 in that it has a centering projection 566. This centering projection 566 is formed on the upper fixing area 60 and extends in FIGS. 12 to 14 substantially perpendicularly upwards.

In the state shown in FIGS. 12 and 13, in which the guide means 510 is fitted on the brake support 540, the snap claws 535b encompass the centering projection 566 in sections. The snap claws substantially encompass the centering recess 566 in an area of the centering projection 566 facing away from the elastic retaining bracket 534. The encompassing achieves a holding and thus a securing of the guide means in the mounted state on the brake support and thus prevents an unintentional radial or tangential release of the guide means from the brake support. The centering recess 534a prevents the centering projection 566 in this case from pressing detrimentally against the elastic retaining bracket 534 in the mounted state, which would counteract an envisaged operating position of the guide means 510.

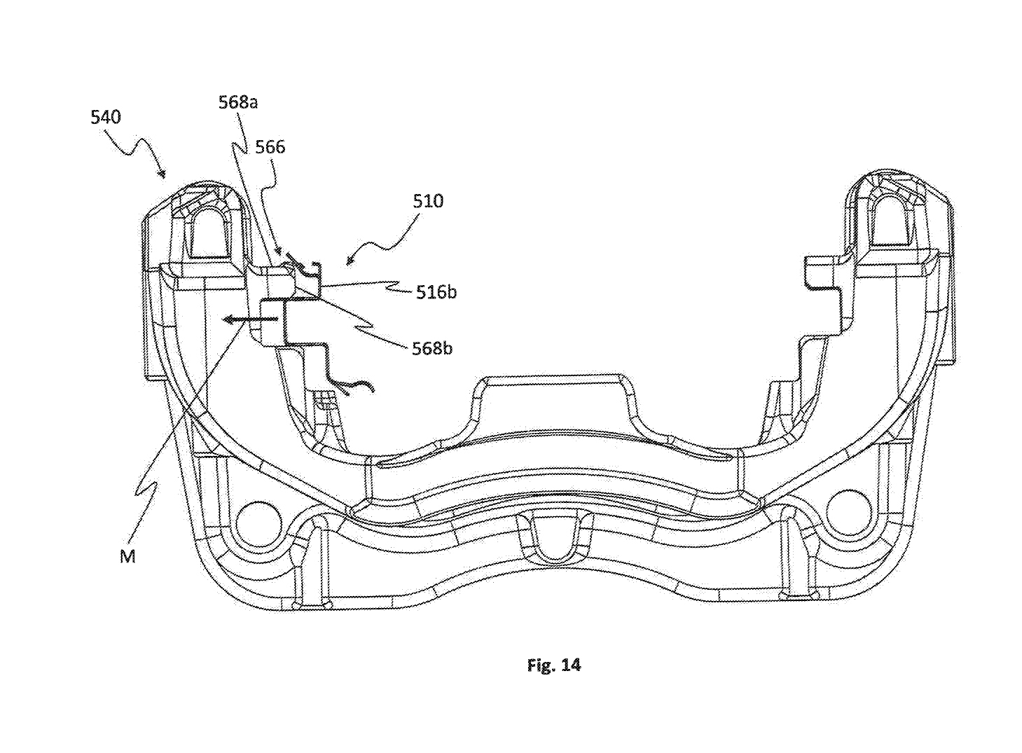

FIG. 14 shows a side view of the other brake support 540 as well as a guide means 510 according to the fifth embodiment to be fitted thereon. The guide means 510 is moved on assembly in the direction of the arrow M and mounted on the brake support 540 by this via the corresponding fixing portions and areas.

It can be recognized in FIG. 14 that the centering projection 566 is formed on an upper surface 568A of the upper fixing area of the brake support 540. More precisely speaking, the centering projection 566 is formed in an area that adjoins a lateral surface 568B of the upper fixing area, i.e. a lateral surface of the upper fixing area facing the stop surface 516b of the guide means 510 in operation. The centering projection 566 has a relatively large transition radius at the transition to the brake support or the upper fixing portion. The centering projection 566 passes over via this transition radius into the lateral surface 568b of the upper fixing portion also.

When mounting the guide means 510 on the brake support 540, i.e. on moving the guide means in the direction of the arrow M, the guide means 510 comes into contact with the centering projection 566 at the earliest opportunity on account of the described formation of this. On continued movement of the guide means in the direction of the arrow M, the centering projection 566 interacts in a positioning manner with the snap claws 535b, whereby the guide means 510 is centered. This makes it easier to mount the guide means correctly on the brake support.

In the mounted state of the guide means 510 on the brake support 540, the snap claws 535b encompass the centering projection 566 substantially in the area of the transition radius.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A guide means for a brake lining arrangement of a disc brake, having a main part, which comprises:
a guiding portion for guiding a guiding projection of the brake lining arrangement, which guiding portion has an upper guiding surface, a lower guiding surface and a connecting surface which connects both of the upper and lower guiding surfaces,
an upper fixing portion for fixing the guiding means on a brake support, which upper fixing portion has an upper contact surface, a lower contact surface and a stop surface which connects both of the upper and lower contact surfaces, and
a lower fixing portion for further fixing the guide means on the brake support,
wherein the stop surface of the upper fixing portion can is configured to be brought into positioning contact with a corresponding portion of the brake support,
wherein the lower fixing portion has at least one lower retaining portion, which engages in a corresponding recess in the brake support and is thereby in retaining engagement with this at least in sections, wherein the lower retaining portion is formed as a projecting tongue, and
wherein the stop surface has an upper retaining portion comprising two sections, which is configured to be brought into positioning contact with the brake support at least in sections, wherein the upper retaining portion is arranged on the guide means so that the upper retaining portion fixes the guide means axially in both directions in a mounted state on the brake support.

2. The guide means according to claim 1, wherein the upper retaining portion comprises at least one retaining surface, which is provided to rest on the brake support.

3. The guide means according to claim 2, wherein the retaining surface runs at an angle to the stop surface in such a way that the retaining surface extends substantially parallel to the lower contact surface of the upper fixing portion.

4. The guide means according to claim 2, wherein the retaining surface is angled along an edge, which extends substantially perpendicularly to lateral edges of the main part.

5. The guide means according to claim 1, wherein the upper retaining portion extends between the stop surface and at least one of the contact surfaces, wherein the retaining surface (22, 222, 322, 422, 522) is connected to one of the contact surfaces.

6. The guide means according to claim 4, wherein the two sections of the upper retaining portion are formed respectively starting out from one of the lateral edges of the guide means in the direction of a center of the guide means.

7. The guide means according to claim 1, wherein the two sections of the upper retaining portion are formed separated from one another.

8. The guide means according to claim 1, wherein the stop surface is formed at least in some sections as elastic retaining brackets.

9. The guide means according to claim 1, wherein the upper contact surface is formed at least in some sections as a clamping component, which is supported in operation with respect to a projection of the brake support and fixes the guide means tangentially on the brake support.

10. The guide means according to claim 9, wherein the clamping component is formed in a portion between the two sections of the upper retaining portion.

11. The guide means according to claim 9, wherein the clamping component has at least two snap claws or is configured in the form of a double tongue, which has two tongue portions.

12. The guide means according to claim 11, wherein the two snap claws or the two tongue portions each have a punctiform or two-dimensional formation for support with respect to the brake support.

13. The guide means according to claim 11, wherein the two snap claws or the two tongue portions at least partially encompass a centering projection on the brake support.

14. The guide means according to claim 1, wherein the stop surface has at least one centering recess.

15. The guide means according to claim 1, wherein lateral insertion tabs are formed on the guiding portion.

16. The guide means according to claim 1, wherein the guiding portion on the connecting surface has at least one laterally or centrally arranged contact claw, which projects beyond the main part of the guide means.

17. The guide means according to claim 16, wherein the at least one contact claw is formed to act in a punctiform or linear manner on the brake support.

18. The guide means according to claim 17, wherein the guiding portion has two laterally arranged contact claws and a centrally arranged contact claw, wherein the laterally arranged contact claws and the centrally arranged contact claw are provided respectively at opposing upper and lower ends of the connecting surface.

19. The guide means according to claim 17, wherein the guiding portion comprises two centrally arranged contact claws, which are arranged at opposing upper and lower ends of the connecting surface.

20. The guide means according to claim 1, wherein the guiding portion has a reset spring acting on the brake lining arrangement.

21. The guide means according to claim 1, wherein a lip section is provided on the lower fixing portion for pretensioning and releasing the guide means.

22. The guide means according to claim 1, wherein the main part has a substantially S-shaped design.

23. The guide means according to claim 1, wherein the guide means is made from sheet metal.

24. The guide means according to claim 1, wherein the guide means is formed in one piece.

25. A disc brake for a motor vehicle braking system, which comprises:
at least one brake lining arrangement, which has a brake lining support and a brake lining mounted on the brake lining support, which lining can be brought into interaction with a brake disc to achieve a braking effect,
at least one brake support, which has a receiving area and an upper fixing area and a lower fixing area, and
at least one guide means according to claim 1, which is fixed on the fixing areas of the brake support by fixing portions thereof and the guiding portion of which is received in the receiving area of the brake support,
wherein the brake lining support has at least one guiding projection, which is guided movably in the guiding portion of the guide means.

26. The disc brake according to claim 25, wherein the upper fixing area of the brake support is formed in the form of a projection, wherein the upper retaining portion of the upper fixing portion of the guide means is configured to be brought into contact with the upper fixing area of the brake support axially in both directions.

27. The disc brake according to claim 25, wherein the upper fixing area has opposed lateral surfaces, on which a recess is provided respectively, in which a section of the upper retaining portion of the upper fixing portion of the guide means respectively engages.
